(19) United States
(12) Patent Application Publication
(10) Pub. No.: US 2024/0182358 A1
(43) Pub. Date: Jun. 6, 2024

(54) COATED CELLULAR GLASS INSULATION SYSTEM

(71) Applicant: Owens Corning Intellectual Capital, LLC, Toledo, OH (US)

(72) Inventors: Steven Badger, Pittsburgh, PA (US); Helen Huang, Katy, TX (US); William F. Sorsby, III, Millersport, OH (US)

(21) Appl. No.: 18/524,422

(22) Filed: Nov. 30, 2023

Related U.S. Application Data
(60) Provisional application No. 63/505,296, filed on May 31, 2023.
(60) Provisional application No. 63/385,791, filed on Dec. 2, 2022.

(51) Int. Cl. C03C 17/42; C03C 11/00; C03C 17/22; C03C 17/32

(52) U.S. Cl. CPC C03C 17/42; C03C 11/00; C03C 17/22; C03C 17/32; C03C 2217/76; E04D 13/16

(57) ABSTRACT

Methods for coating a cellular glass insulation material and a coated cellular glass insulation system for insulating the roof of a structure. The method comprises applying a coating system to at least one surface of a cellular glass block, the coating system comprising a first coating and a second coating, wherein the coating system provides durability and prevents water vapor intrusion. The coated cellular glass insulation system is comprised of blocks of coated cellular glass insulation and a membrane.

### CROSS-REFERENCE TO RELATED APPLICATIONS

This application claims priority to and any benefit of U.S. Provisional Application No. 63/385,791, filed Dec. 2, 2022, and U.S. Provisional Application No. 63/505,296 filed on May 31, 2023, the contents of which are incorporated herein by reference in their entireties.

### FIELD

The present invention relates to insulation systems for use in exterior insulation applications, and more particularly, to roofing systems that avoid the problems associated with conventional protected membrane roofing assemblies.

### BACKGROUND

Cellular glass is a preferred choice for many insulation applications due to its ability to maintain its shape under strenuous conditions including both high and low temperatures as well as its closed-cell makeup, making it impermeable to vapor. It is used to provide thermal insulation for a wide range of applications such as insulating walls, roofs and floors of a building as well as industrial applications such as insulating pipes and tanks. Cellular glass is also often used as insulation in cryogenic spill systems to help reduce the rate of vaporization and provide thermal shock protection to concrete and steel. While generally very durable, one area that poses potential challenges for cellular glass insulation is continual exposure to the elements. Specifically, cellular glass is known to degrade over time when continually exposed to environmental conditions, such as UV radiation, moisture, and hot-cold temperature cycling. Various conventional coating compositions have been used as an attempt to protect the insulation from degradation. However, such conventional coatings have proven unsatisfactory in some instances, as they tend to delaminate and crack easily.

As mentioned above, one application for cellular glass insulation is roof insulation. In a conventional roof assembly, a membrane that protects from environmental elements, such as, e.g., moisture, is placed on the exterior of an insulation layer. However, in protected membrane roof assemblies (“PMRA,” also known as an inverted roof), insulation is placed on the exterior of the membrane. In this arrangement, the membrane is “protected” from the elemental conditions by the insulation. However, the insulation itself is exposed and therefore must be able to withstand environmental elements without degradation.

Accordingly, there is a need for improved coating compositions for application to insulation products, such as cellular glass insulation for use as roof insulation or in cryogenic liquid spill systems, that can sufficiently seal and protect the insulation material without degradation, cracking, and peeling upon exposure to environmental conditions.

### SUMMARY

The general inventive concepts are based, in part, on the recognition that conventional cellular glass coatings and sealants are disfavored or have proven ineffective at sealing against the intrusion of moisture and degradation from heat and/or UV exposure. Therefore, a need exists for a cellular glass sealant/protectant coating that can 1) bond effectively to the cellular glass surface (i.e., reduced delamination), 2) prevent moisture intrusion (i.e., improved hydrophobicity), and 3) survive for extended periods of time in harsh environments such as hot-cold temperature cycling (to prevent the need for removal and replacement). Applicant has discovered that a coating system comprising an inorganic-based material, such as a silicate material and/or a hydrated material (such as a hydrated lime material) can achieve these ends.

Various exemplary embodiments describe a coated cellular glass insulation material, wherein the coating system is thermally stable, resists delamination, can be applied by various means, including spraying, is fire resistant by E84 standards, is water resistant, and has good freeze-thaw performance.

Various exemplary embodiments contemplate a coated cellular glass insulation product. The product comprises a cellular glass insulation material having a plurality of surfaces and a coating system disposed on at least one of the surfaces. The coating system comprising a first coating layer applied directly to the at least one surface of the cellular glass insulation material and, optionally, a second coating layer disposed on at least a portion of the first coating layer. In any of the exemplary aspects, the first coating may comprise at least one of a silicate-based material and/or hydrated material and the second coating layer comprises a water-repellant coating.

Various exemplary embodiments contemplate a method of protecting a cellular glass insulation material. The method comprises providing a cellular glass material having a plurality of surfaces, applying a first coating layer to at least a portion of one of the surfaces of the cellular glass insulation material, and, optionally, applying a second coating layer to at least a portion of the first coating layer. In any of the exemplary aspects, the first coating layer may comprise any of a silicate-based material, a hydrated material, and mixtures thereof, and the second coating layer comprises a water-repellant coating.

Various exemplary embodiments contemplate a method of insulating a structure. The method comprises providing a water impermeable layer and a plurality of cellular glass insulation materials, applying a coating system to at least one surface of the plurality of cellular glass insulation materials to form a coated cellular glass insulation product, positioning the water impermeable layer on the structure, and positioning the coated cellular glass insulation products on an exterior surface of the structure. In various exemplary aspects, the coating system comprises a first coating layer applied directly to at least a portion of one surface of each cellular glass insulation materials and, optionally, a second coating layer applied to at least a portion of the first coating layer.

Other aspects and features of the general inventive concepts will become more readily apparent to those of ordinary skill in the art upon review of the following description of various exemplary embodiments in conjunction with the accompanying figures.

### BRIEF DESCRIPTION OF THE DRAWINGS

The general inventive concepts, as well as embodiments and advantages thereof, are described below in greater detail, by way of example, with reference to the drawings in which:

FIG. 1 is an image of a cellular glass insulation block coated with a conventional coating system made from waterglass, scrap cellular glass, and aluminum phosphates.

FIG. 2 is an image of a cellular glass insulation block coated with a coating system according to the general inventive concepts.

FIG. 3 is a box plot of max crushing force for several cellular glass insulation blocks.

FIG. 4 is an image of sample cellular glass insulation blocks coated with varying amounts of a potassium silicate-based coating material, using varying application methods, coating thicknesses, and optional topcoats, according to the general inventive concepts and subjected to at least 30 cycles of Freeze/Thaw testing according to ASTM C666.

### DETAILED DESCRIPTION

Unless defined otherwise, all technical and scientific terms used herein have the same meaning as commonly understood by one of ordinary skill in the art to which the embodiments belong. Although any methods and materials similar or equivalent to those described herein can be used in the practice or testing of the various embodiments, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references. In the drawings, the thickness of the lines, layers, and regions may be exaggerated for clarity. It is to be noted that like numbers found throughout the figures denote like elements. The terms “composition” and “inventive composition” may be used interchangeably herein.

As used in the specification and the appended claims, the singular forms “a,” “an,” and “the” are intended to include the plural forms as well, unless the context clearly indicates otherwise.

Unless otherwise indicated, all numbers expressing quantities of ingredients, chemical and molecular properties, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present exemplary embodiments. At the very least, each numerical parameter should be construed in light of the number of significant digits and ordinary rounding approaches.

Unless otherwise indicated, any element, property, feature, or combination of elements, properties, and features, may be used in any embodiment disclosed herein, regardless of whether the element, property, feature, or combination of elements, properties, and features was explicitly disclosed in the embodiment. It will be readily understood that features described in relation to any particular aspect described herein may be applicable to other aspects described herein provided the features are compatible with that aspect. In particular: features described herein in relation to the method may be applicable to the insulation product and vice versa; features described herein in relation to the method may be applicable to the foamable cellular glass composition and vice versa; and features described herein in relation to the insulation product may be applicable to the foamable cellular glass composition and vice versa.

Every numerical range given throughout this specification and claims will include every narrower numerical range that falls within such broader numerical range, as if such narrower numerical ranges were all expressly written herein.

As it pertains to the present disclosure, “closed cell” refers to a foam having a plurality of cells, at least 95% of which are closed. However, in the present application, cells may be “open cells,” closed cells, or a mixture thereof (i.e., certain embodiments disclosed herein may exhibit an “open cell” foam structure or a blend of open cells and closed cells).

The general inventive concepts relate to systems for and methods of insulating a structure using an insulation material, such as cellular glass, and for coating an insulation material to provide improved durability and resistance to external elements. Although the subject disclosure primarily describes cellular glass insulation, it is to be appreciated that the present inventive concepts are similarly applicable to polymer foam insulation, such as extruded or expanded polymer foam insulation. Additionally, although the below disclosure provides an exemplary method for forming an insulation product, it is to be appreciated that other methods for forming insulation products are contemplated herein, such as spray foam, extruded foam, expanded foam, and the like.

While the discussion presented herein is focused on insulation applications, those of ordinary skill in the art will recognize the applicability of the cellular glass systems described herein is not limited to the specific embodiments discussed herein. In any of the embodiments, the “cellular glass insulation material” and “coated cellular glass insulation product” may comprise an insulation block or panel, including a block or panel for insulating roofs, walls, floors of a building, cryogenic spill systems, or the like.

The general inventive concepts contemplate a coated insulation product and methods of insulating a structure using the coated insulation products. In any of the aspects disclosed herein, the insulation product may be formed having opposed major surfaces (i.e., a top surface and a bottom surface) and a plurality of minor surfaces extending therebetween. A coating system is applied to at least one surface of the insulation material. The coating system may comprise a single layer of coating or may comprise two or more layers of coating. For instance, the coating system may comprise or consist of a first coating layer and a second coating layer. The first coating layer is applied directly to at least a portion of one surface of the insulation material and the optional second coating may be applied on at least a portion of the first coating. The first coating layer and second coating layer may be the same or different coating compositions. For instance, the first coating may comprise an inorganic coating material (such as a silicate material and/or a hydrated material), water, and optional additives, such as a filler. If present, a second or additional coating may comprise a water-repellant coating, for example.

In any of the aspects of the present inventive concepts the insulation material may comprise cellular glass. Cellular glass is a non-porous, substantially closed-cell foam material that is rigid in structure and is impervious to water vapor. Cellular glass insulation is categorized (for the EU) in EN 13167 and/or ASTM C552. While it is generally chemically resistant, vapor resistant, durable, and has good thermal insulating properties, cellular glass is known to degrade over time when exposed to water and hot-cold temperature cycling. Often the cellular glass insulation can lose insulative capacity, requiring removal and/or replacement when exposed to the elements for extended periods of time (e.g., as a part of a roof insulation system).

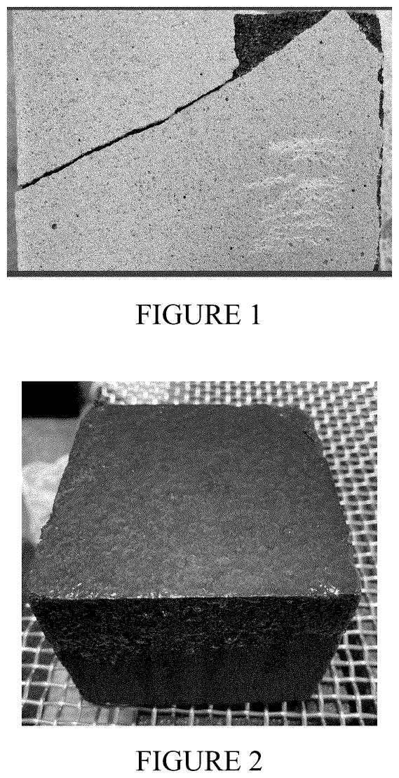

The general inventive concepts are based, in part, on the discovery that conventional cellular glass coatings/sealants, such as those made from waterglass, scrap cellular glass, and aluminum phosphates, and exemplified in FIG. 1, do not sufficiently protect the surface of a cellular glass insulation material exposed to the elements. Applicant has found that certain silicate material-based (such as silica-sol and/or alkali-silicate based systems) and/or hydrated material-based coating systems (such as hydrated lime-based systems) form a strong bond with the surface of the cellular glass and can provide enhanced sealing and durability to allow the use of cellular glass insulation in exterior applications (e.g., roofing insulation and cryogenic spill tank insulation), allowing for long-term use and insulation (See, e.g., FIG. 2). The novel coating systems protect the cellular glass material, for example to improve weather resistance where cellular glass blocks are located on the exterior of a building (i.e., as a part of a PMRA insulation system). The coating systems provide water resistance, improved hot-cold temperature cycling performance (such as reduced cracking and improved adhesion), and/or fire resistance to the insulation material. The coating systems are further non-combustible.

In addition to the properties (such as water resistance or reaction to fire) of the coating system, the compatibility of the coating with the surface of the insulation material is also essential to the performance of the coating. It is desirable that any coating sufficiently adheres to the surface of the insulating material substrate so that the coating does not easily delaminate or shear from the insulation material during its operable lifespan. It is therefore desirable to provide a coating system having one or more of improved adhesion, improved water resistance, and improved reaction to fire.

The cellular glass insulation for use according to the general inventive concepts is characterized by a stable thermal conductivity that does not substantially change when exposed to extreme environmental conditions. The cellular glass insulation is uniquely characterized within the insulation market since the product is formed using an insulating cell gas composition that cannot escape the glass structure. Those of ordinary skill in the art will recognize that different cellular glass densities and thicknesses will provide different properties and performance. The general inventive concepts are related to increasing performance of the combination of cellular glass and a coating/sealant system to prevent or mitigate drawbacks of conventional cellular glass insulation systems.

In order to avoid undermining the long-term mechanical/thermal characteristics of a cellular glass installation, the coating needs to effectively seal the cellular glass material from the elements. Such a coating system must provide a vapor/insulative barrier despite the extreme environmental conditions under which cellular glass insulation systems are often used. Likewise, the sealant/coating system must demonstrate the ability to withstand the conditions over extended periods (e.g., up to and including 5 years) of exposure to weather and heat.

While conventional coating/sealant materials are suitable for a variety of conditions, they are not without drawbacks (e.g., delamination and cracking). Thus, there is a need for an improved coating system that exhibits good sealant and insulative properties under harsh environmental conditions, that is compatible with cellular glass insulation (e.g., good compatibility and adhesion), and that lacks the drawbacks of conventional coatings, while providing adequate protection from hot-cold cycling and e.g., UV exposure and avoiding known issues with cracking and delamination.

Accordingly, the novel coating system includes at least one coating layer (hereinafter the “first coating layer”) comprising an inorganic material, such as a silicate-based material and/or a hydrated material, such as a hydrated lime material. In any of the exemplary embodiments, the silicate-based material may comprise any material derived from silica, such as, for example, silica-sol (also known as colloidal silicic acid and includes a suspension of spherical hydroxylated silicon dioxide nanoparticles in a liquid), alkali-silicate materials (i.e., potassium silicate, sodium silicate, magnesium silicate, calcium silicate, and the like), silicone-based materials, or combinations thereof. Silicate materials comprising silicon dioxide nanoparticles have been shown to enable substantial adhesion to surfaces. The silicate material may optionally be combined with water, a thinner/dilution material, and/or one or more optional additives (e.g., inorganic pigments, mineral fillers, polymers, or other filler/binders) to form a silicate coating system. One exemplary silicate-based coating may comprise a blend of silica-sol, potassium silicate binders, an acrylate copolymer, inorganic pigments and/or mineral fillers. Another exemplary silicate-based coating may comprise a blend of a mineral/silicate material and silicone material. The mineral silicate material may comprise, for example, an alkali silicate.

Alternatively, or in addition to the silicate material, the coating system may comprise a hydrated material. The hydrated material may comprise or consist of any type of lime material, such as, for example, calcium carbonate, calcium sulfate (gypsum), calcium oxide (also known as quick lime), calcium hydroxide (also known as hydrated lime), natural hydraulic lime, dolomite, semi-hydraulic lime; hydrated alumina; hydrated magnesite (Mg(OH)₂ and Mg₅(CO₃)₄(OH)₂); muscovite (KAl₂(AlSi₃O₁₀)(F,OH)₂); huntite (MgCa(CO₃)₄); brucite; and the like, or mixtures thereof. The terms “hydraulic lime,” “natural hydraulic lime,” and “hydraulic lime-based coating” may be used synonymously herein and refer to materials formed by calcination of argillaceous limestone (and products made therefrom). The resulting material is ground and hydrated to produce natural hydraulic lime (NHL). Natural hydraulic lime 5.0 is a category of natural hydraulic lime. In certain exemplary embodiments, the hydrated material is a natural hydraulic lime, including natural hydraulic lime 5.0. The hydrated material may then be combined with water and one or more optional additives (e.g., a fibrous or other filler) to form a hydrated coating system.

As introduced above, the first coating layer comprises an inorganic material, such as a silicate-based material and/or a hydrated material. One way of characterizing the first coating layer is by weight percentage of the ingredients as prepared (i.e., including the solid ingredients and water). As prepared, the first coating layer may comprise water in an amount from about 10 wt. % to 80 wt. % of the first coating layer including, for example, 12 wt. % to 75 wt. %, 15 wt. % to 70 wt. %, 18 wt. % to 65 wt. % and 20 wt. % to 50 wt. %, including any endpoints and subranges therebetween. In any of the embodiments disclosed herein, water may be present in the first coating layer in an amount between 15 wt. % and 30 wt. %, such as, for example, between 16 wt. % and 28 wt. %, and between 18 wt. % and 25 wt. %, including any endpoints and subranges therebetween.

Accordingly, in embodiments comprising a silicate-based material, the silicate material may be present in the first coating layer in an amount from about 20 wt. % to 100 wt. % of the first coating layer including, for example, 22 wt. % to 90 wt. %, 25 wt. % to 85 wt. %, 28 wt. % to 80 wt. % and 30 wt. % to 75 wt. %, including any endpoints and subranges therebetween. In any of the embodiments disclosed herein, the silicate-based material may be present in the first coating layer in an amount between 20 wt. % and 60 wt. %, such as, for example, between 22 wt. % and 58 wt. %, and between 28 wt. % and 50 wt. %, including any endpoints and subranges therebetween.

In embodiments comprising the hydrated material, such material may be present in the first coating layer in an amount of at least about 8% by weight, including about 10% to about 60% by weight, about 20% to about 60% by weight, about 30% to about 60% by weight, about 35% to about 55% by weight, about 40% to about 48%, about 42% to about 45%, and about 43% by weight, based on the total weight of the first coating layer, including any endpoints and subranges therebetween.

As mentioned above, the first coating layer may optionally include one or more additives, such as, for example, polymers, pigments, hydrophobic agents, colorants, alcohols, and filler(s). The polymer additives may comprise a homopolymer or a copolymer comprising one or more co-monomers, such as, without implied limitation, vinyl chloride; vinyl alcohols; vinyl esters, such as, for example, vinyl acetate; vinyl ethers; acrylic acids; acrylic esters; acrylate, acrylamides; methacrylic acids; methacrylic esters. Exemplary fillers include: crushed cellular glass powder (also referred to as cellular glass powder), sand (e.g., silica sand, pacific sand, etc.), calcium carbonate, limestones such as dolomite limestone and Mississippi limestone, talc, wollastonite, barium sulfate, carbon black, etc. Table 1 shows average diameter measurements for several exemplary filler materials. In some exemplary aspects, the filler may comprise a combination of fillers, such as a combination of limestone, wollastonite, and the like.

TABLE 1

| | D10 (μm) | D50 (μm) | D90 (μm) |
|---|---|---|---|
| Silica Sand | 139 | 259 | 450 |
| Limestone (Glass Production) | 9 | 355 | 904 |
| FOAMGLAS Scrap | 40 | 140 | 272 |

If present, the filler material may be included in the first coating layer in an amount of about 1% to about 50% by weight, based on the total weight of the first coating layer, including about 2% to about 40% by weight, about 3% to about 30% by weight, about 5% to about 20% by weight, about 8% to about 15% by weight, about 5% by weight to about 10% by weight, and about 7% by weight to about 12% by weight, including any endpoints and subranges therebetween. In certain exemplary embodiments, the inorganic material and the filler are present in the first coating layer in a weight ratio of about 5:1 to about 1:5, about 4:1 to about 1:4, about 3:1 to about 1:3, about 3:1 to about 2:1, and a weight ratio of about 2.5:1. An exemplary formulation of the first coating layer includes 2,000-3,000 g of natural hydraulic lime, 600-1000 g inorganic filler (i.e., cellular glass powder, pacific sand, dolomite limestone, sand etc.), 1,500 to 2,500 g of water, a colorant, and optionally a hydrophobic agent.

As mentioned above, as the filler material is optional, in some exemplary embodiments, the first coating layer is free of filler, or includes less than 5% by weight of filler.

As mentioned above, the first coating layer may further include a drying agent, such as an alcohol. If present, the alcohol may be included in the first coating layer in an amount of about 0.01% to about 10% by weight, based on the total weight of the first coating layer, including about 0.05% to about 8% by weight, about 0.1% to about 6% by weight, about 0.5% to about 5% by weight, about 0.75% by weight to about 4% by weight, about 1% by weight to about 3% by weight, and about 1.25% by weight to about 2.5% by weight, including any endpoints and subranges therebetween.

The first coating layer may optionally include fibers, such as glass fibers, mineral wool fibers, stone or rock wool fibers, natural fibers, synthetic fibers, and the like. When present, the fibers may be included in the first coating layers in an amount of about 0.5% to about 5% by weight, including about 0.7% to about 3.6% by weight, about 1% to about 2% by weight, and about 1.5% by weight. In certain exemplary embodiments, the fiber is fiberglass. One exemplary type of fiberglass suitable for use in the inventive coating layer is Owens Corning's Cem-FIL Anti-CRAK® HD 3 mm. Those of ordinary skill in the art will recognize that other similar fibers, including those with longer fiber lengths (i.e., 6 mm and/or 12 mm) could also be included.

Another way of describing the first coating layer is by amount of the solid ingredients (also called solids content) in the coating layer. Thus, the inorganic material may be present in the first coating layer in an amount from about 15% to about 100% by weight, such as, for example, from about 26% to about 95% by weight, about 45% to about 90% by weight, and about 58% to about 85% by weight, and about 68% to about 75% by weight, based on the weight of the total solids content of the first coating layer, including any endpoints and subranges therebetween. When present, the filler may be included in an amount from about 15% to about 84% by weight, such as, for example, about 20% to about 74%, about 22% to about 42%, about 25% to about 42%, and about 26% to about 32%, including any endpoints and subranges therebetween.

The first coating layer may be applied to at least one surface of the insulation material in an amount of about 15 ft²/gallon to about 600 ft²/gallon, including about 20 ft²/gallon to about 500 ft²/gallon, about 25 ft²/gallon to about 400 ft²/gallon, about 30 ft²/gallon to about 300 ft²/gallon, about 35 ft²/gallon to about 200 ft²/gallon, and about 40 ft²/gallon to about 150 ft²/gallon, including all endpoints and subranges therebetween.

In any of the exemplary embodiments, the first coating layer may be characterized by the amount of coating applied to a surface of the insulation material per square meter, such as amounts from 2000 g/m² to about 4500 g/m², including about 2600 g/m² to about 4350 g/m², about 2730 g/m² to about 4125 g/m², about 2800 g/m² to about 3750 g/m², about 2900 g/m² to about 3500 g/m², about 2950 g/m² to about 3200 g/m², and about 3000 g/m², including all endpoints and subranges therebetween.

The first coating layer may be applied to at least one surface of the insulation material such that the coating has an average thickness of at least 75 μm, including, for example, an average thickness between 90 μm and 1,200 μm, 100 μm to 1,000 μm, 125 μm and 850 μm, 175 μm and 800 μm, 200 μm and 750 μm, 250 μm and 700 μm, 300 μm to 650 μm, and between 350 μm and 600 μm, including all endpoints and subranges therebetween. It has been surprisingly discovered that applying the first coating layer such that the coating has a thickness of at least 75 μm produces a coated insulation product with particularly improved properties, such as FSI and SDI values of no greater than 10, and preferably, no greater than 5, and no greater than 2.5. In any of the exemplary embodiments, coated insulation products that have a coating thickness layer of at least 75 μm demonstrate FSI and SDI values of zero.

The coating system may further optionally include one or more additional coating layers that function synergistically with the first coating layer (or sealant) to provide additional water-proofing, durability, freeze-thaw protection, and weather-resistance to the coated insulation product. In some exemplary aspects, the first coating layer is applied directly to the insulation material and a second coating layer is provided on at least a portion of the first coating layer. The second coating layer may comprise a protectant coating (or water-repellant coating), such as, for example, a coating comprising acrylate copolymers, silane/siloxane emulsions, silane, fluoropolymers and fluorocarbons, silicates and combinations thereof. In certain exemplary embodiments, the second coating layer is an acrylate copolymer, including a fluoroalkyl copolymer solution. One exemplary fluoroalkyl copolymer solution is Mineral Shield, commercially available from Romabio Paints, LLC, 3555 Atlanta Industrial Parkway NW, Atlanta GA. In certain exemplary embodiments, the second coating layer is a silane/siloxane emulsion. Exemplary silane/siloxane emulsions include Stabilized Earth Water Repellant W by Tech-Dry Building Protection Systems, Siloxa-Tek® 8500 by GhostShield®, and Sure Klean® Weather Seal Siloxane PD by Prosoco, Inc. An exemplary silane coating includes Silan 100 Water Repellent by Keim Mineral Paints. An exemplary fluorocarbon coating includes R97 by Cathedral Stone® Products, Inc. The second coating layer may be applied directly to the insulation, or in certain aspects may be diluted with water prior to application to the insulation product, including dilution of 9:1 by volume. In certain exemplary embodiments, the second coating layer is applied to the insulation product in one or more coats, including two or three coats or more.

The second coating layer may be applied to at least a portion of the surface the first coating layer in an amount of about 0.05 L/m² to about 2.5 L/m², including about 0.08 L/m² to about 2 L/m², including about 0.1 L/m² to about 1.6 L/m², including, 0.12 L/m² to about 1.1 L/m², including about 0.14 L/m² to about 0.9 L/m², including about 0.2 L/m² to about 0.65 L/m², including about 0.22 L/m² to about 0.5 L/m², and including about 0.28 L/m².

As discussed above, mechanical stability of an insulation system (including the sealant/coating) is an important property for exterior applications. As the insulation system is providing primary protection for the structure, if there is a mechanical failure of an insulation block, the system will fail, requiring costly repair/replacement. By using a coating system with improved adhesion, sealing, and protection of the cellular glass insulation material can be achieved even when the cellular glass insulation product is continually exposed to water and environmental conditions for extended periods of time.

The coated cellular glass insulation product produced in accordance with the general inventive concepts has a water absorption (volume %) in accordance with ASTM C240 of no greater than 1%, such as, for example, no greater than 0.8%, no greater than 0.6%, no greater than 0.5%, no greater than 0.3%, no greater than 0.2%, and no greater than 0.1%. The coated cellular glass insulation product also meets the surface burning requirements set forth in ASTM E84. Through the E84 test, both Flame Spread Index (FSI) and Smoke Developed Index (SDI) are reported for a given sample. FSI is the measurement for the speed at which flames progress across the interior surface of a building, while SDI measures the amount of smoke a sample emits as it burns. The coated cellular glass insulation product produced in accordance with the present inventive concepts achieves an FSI of no greater than 50, including FSI values of no greater than 45, no greater than 40, no greater than 35, no greater than 30, no greater than 25, no greater than 20, no greater than 17, no greater than 15, no greater than 12, no greater than 10, no greater than 7, no greater than 5, no greater than 2.5, and no greater than 1. In any of the exemplary embodiments, the FSI value of the coated cellular glass insulation product may be 0. The coated cellular glass insulation product further achieves an SDI value of no greater than 50, including SDI values of no greater than 45, no greater than 40, no greater than 35, no greater than 30, no greater than 25, no greater than 20, no greater than 17, no greater than 15, no greater than 12, no greater than 10, no greater than 7, no greater than 5, no greater than 2.5, and no greater than 1. In any of the exemplary embodiments, the SDI value of the coated cellular glass insulation product may be 0. In any of the exemplary embodiments, the coated cellular glass insulation product has an FSI value of 0 and an SDI value of 0.

The general inventive concepts contemplate compositions for and methods of insulating a structure (e.g., a roof) with insulation materials/products, such as cellular glass insulation, wherein some or all of the insulation product may be exposed to water and environmental conditions. Accordingly, the insulation product is coated with a coating system on at least a portion of one surface of the insulation, in accordance with the present inventive concepts. In certain exemplary embodiments, the coating system is applied to more than one surface of the cellular glass insulation material. In certain exemplary embodiments, the coating system is applied to the entire surface of the cellular glass insulation material. Any of the exemplary embodiments may be directed to a coated cellular glass insulation product with improved resistance to water and environmental conditions.

Various exemplary embodiments contemplate a method of protecting an insulation material, such as a cellular glass insulation material. The method comprises providing an insulation material having one or more surfaces, applying a first coating layer to at least a portion of one of the surfaces of the insulation material, and, optionally, applying a second coating layer to at least a portion of the first coating layer. In certain exemplary aspects, the first coating layer comprises an inorganic material, such as a silicate-based material and/or a hydrated material, water, and an optional filler and the second coating layer comprises a silane, fluoropolymer, or fluorocarbon.

Various exemplary embodiments contemplate a method of insulating a structure. The method comprises providing a water impermeable layer and a plurality of cellular glass insulation materials, applying a coating system to at least one surface of the plurality of cellular glass insulation materials to form a coated cellular glass insulation product, positioning the water impermeable layer on the structure, positioning the coated cellular glass insulation products on an exterior surface of the structure. In various exemplary aspects, the coating system comprises a first coating layer applied directly to at least a portion of one surface of each cellular glass insulation materials and a second coating layer applied to at least a portion of the first coating layer.

The general inventive concepts further contemplate a method of insulating a structure. The method comprises providing a plurality of cellular glass insulation materials and a coating/sealant according to the general inventive concepts. The method further comprises applying a first coating layer to at least one surface of the cellular glass insulation material and positioning the cellular glass insulation product on an exterior surface of a structure (e.g., a roof) or in a cryogenic spill containment system. In certain exemplary embodiments, the coated cellular insulation product is used in conjunction with a membrane roof (e.g., to form a PMRA). In certain exemplary embodiments, the coated cellular insulation product is used to line steel and concrete used to construct liquid natural gas (LNG) spill pits. In certain embodiments, more than one surface of the cellular glass insulation product is coated with the coating system, including the entire exterior of the cellular glass insulation product.

The following examples illustrate features and/or advantages of the systems and methods according to the general inventive concepts. The examples are given solely for the purpose of illustration and are not to be construed as limitations of the general inventive concepts, as many variations thereof are possible without departing from the spirit and scope of the general inventive concepts.

### EXAMPLE 1

Cellular glass insulation samples according to the general inventive concepts were made and subjected to freeze-thaw temperature cycling, in accordance with a modified ASTM C666 method. The cellular glass insulation samples were coated with a potassium silicate-based coating in accordance with Tables 2 and 3 below. The samples were then submerged face down in 1-3 mm water in a shallow container at 15° C. for four hours. The temperature was then lowered to −18° C. and maintained for four more hours. The temperature is then raised to about 15° C. and the cycle was repeated for 30 cycles.

TABLE 2

| Sample: Potassium | |
|---|---|
| Silicate | Coat Amount/Application Method |
| EU | CONTROL, coated with a commercial |
| | waterglass mixture. |
| P1 | 60 ft²/gallon, roll coated |
| P2 | 30 ft²/gallon, spray coated |
| P3 | 30 ft²/gallon, spray coated, diluted 10% |

TABLE 3

| Topcoat | |
|---|---|
| Designation | Chemistry |
| A | Silane/siloxane Blend |
| B | Water-based silane/siloxane water repellent |
| C | Solvent-free, silane-based water repellent |
| D | Fluorocarbon emulsion |

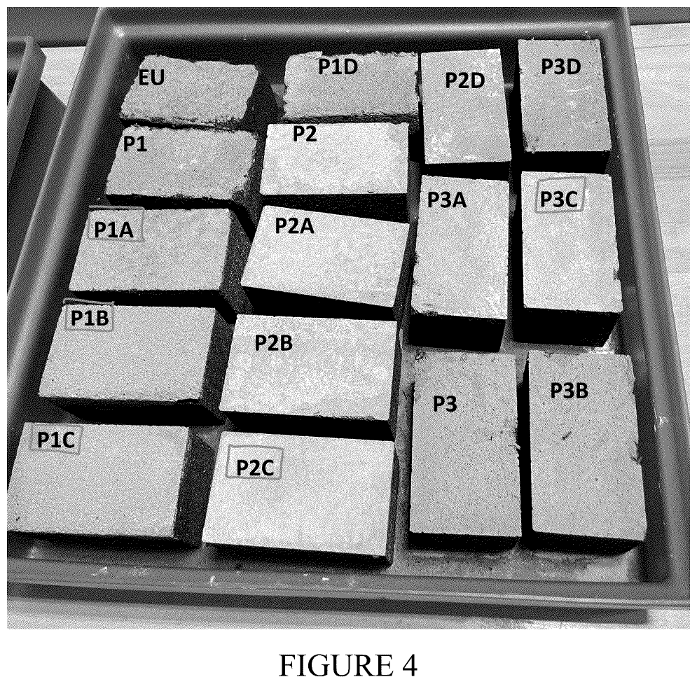

The coated cellular glass insulation products according to the general inventive concepts showed no delamination or cracking after 30 cycles and illustrated a better-quality coating than the Control, as illustrated in FIG. 4. The thicker coatings demonstrated minor delamination in the top layer of the coating, but the bottom layer continued to adhere to the cellular glass product.

### EXAMPLE 2

A series of cellular glass insulation blocks were tested for surface hydrophobicity. The samples included: a conventional coated cellular glass insulation block commercially available in Europe (Control) that includes a waterglass-based coating with aluminum phosphate, a cellular glass insulation product with a first coating layer comprising hydraulic lime (Sample A), a cellular glass insulation product that includes a first coating layer comprising hydraulic lime and one second coating layer (Sample B), and a cellular glass insulation product that includes a first coating layer comprising hydraulic lime and two second coating layers (Sample C). Each of the samples were exposed to water via spraying/sprinkling water droplets onto the surface of the coated insulation product. The Control sample showed little hydrophobicity, and water penetrated the surface and showed very little beading. Sample A, with only the first coating applied thereon, showed increased beading, compared to the Control, and minimal surface penetration. Samples B and C, which included both the first and second coating layers, showed very good hydrophobicity with no penetration and complete beading of the water on the surface of the insulation.

### EXAMPLE 3

Cellular glass insulation products according to the general inventive concepts were made with both a first and second coating layer and were subjected to freeze-thaw temperature cycling. Each cycle consists of 8 hours of immersion in water at 20° C. followed by a freeze chamber cycle at −20° C. The coated cellular glass insulation products according to the general inventive concepts showed no delamination after 28 cycles.

### EXAMPLE 4

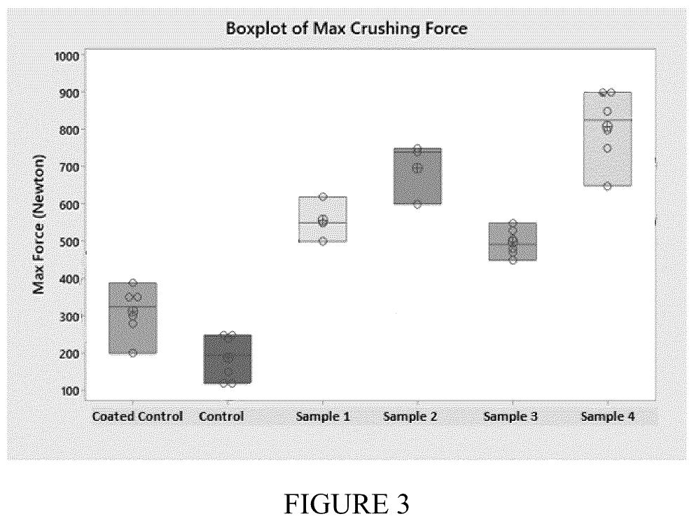

A series of cellular glass insulation products were prepared to test max crushing force, whereby a Bluehill Instron recorded the max force that occurs upon an initial crush with a 1″ diameter probe contacting the coated surface (the “punch crushing test”). The results are shown in FIG. 3. The samples include a thermal insulation segment with a conventional coating that includes waterglass and aluminum phosphate (Coated Control), an uncoated cellular glass insulation block (Uncoated Control), and samples coated with both a first and second coating layer system according to the general inventive concepts (i.e., Samples 1-4). Samples 1 and 2 each included a first coating layer comprising natural hydraulic lime and crushed cellular glass powder as a filler made according to the following formula: 2,250 g of Natural hydraulic lime, 900 g cellular glass powder (i.e., filler), 1,900 g of water, and a colorant. After application of the first coating layer, Samples 1 and 2 were coated with either of two second coating layers (i.e., a protective layer of either an acrylate copolymer including a fluoroalkyl copolymer or a silane/siloxane emulsion). Samples 3 and 4 were coated with a first coating layer made according to the following formula:75 g of lime 5.0, 15 g of pozzolan, and 54 g of water. After application of the first coating layer, Samples 3 and 4 were coated with either of two second coating layers (i.e., a protective layer of either an acrylate copolymer including a fluoroalkyl copolymer or a silane/siloxane emulsion). Qualitatively, the Coated Control coating was brittle and showed cracking and signs of delamination during the punch crushing test, whereas Samples 1-4 did not show signs of cracking.

### EXAMPLE 5

A series of coated cellular glass insulation blocks were prepared according to the general inventive concepts (i.e., with an natural hydraulic lime and powdered cellular glass first coating layer as described above and each of two different second coatings (i.e., a protective layer of either an acrylate copolymer including a fluoroalkyl copolymer or a silane/siloxane emulsion)) and were tested under ASTM E84 for fire resistance. The samples coated according to the general inventive concepts showed a flame spread index of 0 and a smoke development index of 0.

### EXAMPLE 6

Cellular glass sections were individually coated with approximately 0.5-1.5 mm of a first coating layer followed by two coats of either an acrylate copolymer including a fluoroalkyl copolymer or a silane/siloxane emulsion. The second coating layers were applied in two coats wet-on-wet in five minutes (i.e., the second coat was applied prior to the first coat of second coating layer fully drying). Samples coated with the first and second coatings according to the general inventive concepts showed no rub off after water droplet spray.

### EXAMPLE 7

Cellular glass insulation samples according to the general inventive concepts were made and subjected to freeze-thaw temperature cycling, in accordance with a modified ASTM C666 method. The cellular glass insulation samples were coated with a potassium silicate-based coating in accordance with Table 4 below. The samples were then submerged face down in 1-3 mm water in a shallow container at 15° C. for four hours. The temperature was then lowered to −18° C. and maintained for four more hours. The temperature is then raised to about 15° C. and the cycle was repeated for 30 cycles.

TABLE 4

| Sample: | | |
|---|---|---|
| Potassium | | |
| Silicate | Coat Amount/Application Method | Topcoat |
| EU | CONTROL, coated with a commercial | No |
| | waterglass mixture. | |
| P14 | 400 g/3 ft², Potassium silicate, roll coated | No |
| P15 | 400 g/3 ft², Potassium silicate, roll coated | No |
| P9D | 400 g/3 ft², Potassium silicate, roll coated | Fluorocarbon |
| | | topcoat |

The coated cellular glass insulation products according to the general inventive concepts (P14, P15, P9D) showed no delamination or cracking after 87 cycles and illustrated a better-quality coating than the Control. The EU Control cracked and showed poor condition after the same 87 cycles.

### EXAMPLE 8—Cryo-Spill

Cellular glass insulation samples (P4 Samples), each coated with a potassium silicate coating in accordance with the general inventive concepts were made and subjected to combustibility testing in accordance with ASTM-E136 and separately, exposed to liquid nitrogen.

Combustibility Test: ASTM-E136 is a fire response test that determines the combustibility of materials, whereby the samples are exposed to a temperature of 750° C. until failure occurs or for at least 30 minutes. Each of the four samples passed the combustibility test and experienced no greater than 3.5% weight loss, and in some instances less than 3% weight loss.

Liquid N₂ Test: A P4 coated cellular glass sample was immersed in liquid N₂ (coated side down) for 45 minutes. Another P4 coated cellular glass sample was exposed to liquid N₂ by pouring the N₂ onto the coated side of the sample. A cellular glass sample with a conventional coating comprising waterglass and aluminum phosphate was also subjected to the liquid N₂ tests (Coated Control). The Coated Control demonstrated cracking on the top (coated) surface after exposure to the liquid nitrogen. In contrast, the P4 coated samples were intact after 45 minutes of exposure and showed no signs of cracking.

Accordingly, it can be seen that the cellular glass insulation samples coated in accordance with the present inventive concepts are non-combustible, resistant to liquid nitrogen damage upon direct contact, and resistant to freeze-thaw/direct water contact damage.

The cellular glass compositions, and corresponding methods of the present disclosure can comprise, consist of, or consist essentially of the essential elements and limitations of the disclosure as described herein, as well as any additional or optional ingredients, components, or limitations described herein or otherwise useful in cellular glass composition applications.

The cellular glass compositions of the present disclosure may also be substantially free of any optional or selected ingredient or feature described herein, provided that the remaining composition still contains all of the required elements or features as described herein. In this context, and unless otherwise specified, the term “substantially free” means that the selected composition contains less than a functional amount of the optional ingredient, typically less than 0.1% by weight, and also including zero percent by weight of such optional or selected essential ingredient.

While the invention has been illustrated and described in detail in the drawings and foregoing description, the same is to be considered as illustrative and not restrictive in character. It should be understood that only the exemplary embodiments have been shown and described and that all changes and modifications that come within the spirit of the invention are desired to be protected.

1. A coated cellular glass insulation product comprising:
a cellular glass insulation material having a plurality of surfaces and a coating system disposed on at least one of the surfaces, the coating system comprising:
a first coating layer applied directly to at least one surface of the cellular glass insulation material in an average thickness of at least 75 μm, the first coating layer comprising an inorganic coating composition; and
optionally, a second coating layer applied to at least a portion of the first coating layer comprising a water-repellant coating, wherein the coated cellular glass insulation product achieves an FSI of no greater than 50 and an SDI of no greater than 50, as tested in accordance with ASTM E84.

2. The coated cellular glass insulation product of claim 1, wherein the inorganic coating composition comprises a silicate-based material.

3. The coated cellular glass insulation product of claim 1, wherein the water-repellant coating is selected from an acrylate copolymer, a silane, a silane/siloxane emulsion, fluoropolymers, fluorocarbons, and combinations thereof.

4. The coated cellular glass insulation product of claim 1, wherein the water-repellant coating is selected from an acrylate copolymer, a silane/siloxane emulsion, fluoropolymers, fluorocarbons, and combinations thereof.

5. The coated cellular glass insulation product of claim 1, wherein the coating system is non-combustible.

6. The coated cellular glass insulation product of claim 2, wherein the silicate-based material comprises silica-sol, alkali-silicate, silicone, or combinations thereof.

7. The coated cellular glass insulation product of claim 6, wherein the alkali-silicate comprises potassium silicate, sodium silicate, magnesium silicate, calcium silicate, or combinations thereof.

8. The coated cellular glass insulation product of claim 1, wherein the first coating layer is present on the surface of the cellular glass insulation material in an amount between 15 ft²/gallon and about 600 ft²/gallon.

9. The coated cellular glass insulation product of claim 1, wherein the inorganic coating composition further includes any one or more of mineral fillers, polymers, pigments, drying agents, alcohols, and hydrophobic agents.

10. The coated cellular glass insulation product of claim 1, wherein the coated cellular glass insulation product achieves an FSI of no greater than 25 and an SDI of no greater than 25, as tested in accordance with ASTM E84.

11. The coated cellular glass insulation product of claim 1, wherein cellular glass insulation product achieves an FSI of no greater than 5 and an SDI of no greater than 5, as tested in accordance with ASTM E84.

12. The coated cellular glass insulation product of claim 1, wherein the coated cellular glass insulation product has a water absorption (volume %) in accordance with ASTM C240 of no greater than 1%.

13. The coated cellular glass insulation product of claim 1, wherein the cellular glass insulation product is roof insulation.

14. The coated cellular glass insulation product of claim 1, wherein the cellular glass insulation product is cryogenics spill tank insulation.

15. A method of producing a coated cellular glass insulation product comprising:
providing a cellular glass insulation material having a plurality of surfaces;
applying a coating system on at least one surface of the cellular glass insulation material, the coating system comprising:
a first coating layer; and
optionally, a second coating layer comprising a water-repellant coating, wherein the first coating layer has an average thickness of at least 75 μm and comprises an inorganic coating composition, wherein the coated cellular glass insulation product achieves an FSI of no greater than 50 and an SDI of no greater than 50, as tested in accordance with ASTM E84.

16. The method of claim 15, wherein the inorganic coating composition comprises a silicate-based material.

17. The method of claim 15, wherein the water-repellant coating is selected from an acrylate copolymer, a silane/siloxane emulsion, fluoropolymers, fluorocarbons, and combinations thereof.

18. The method of claim 16, wherein the silicate-based material comprises silica-sol, alkali-silicate, silicone, or combinations thereof.

19. The method of claim 18, wherein the alkali-silicate comprises potassium silicate, sodium silicate, magnesium silicate, calcium silicate, or combinations thereof.

20. The method of claim 15, wherein the first coating layer is present on the surface of the cellular glass insulation material in an amount between 10 ft²/gallon to about 600 ft²/gallon.
